(19) United States
(12) Patent Application Publication
(10) Pub. No.: US 2011/0286180 A1
(43) Pub. Date: Nov. 24, 2011

(54) HEAT DISSIPATING DEVICE

(75) Inventor: ZHI-BIN GUAN, Tu-Cheng (TW)

(73) Assignee: HON HAI PRECISION INDUSTRY CO., LTD., Tu-Cheng (TW)

(21) Appl. No.: 12/843,075

(22) Filed: Jul. 26, 2010

(30) Foreign Application Priority Data
May 20, 2010 (TW) 99116203

(51) Int. Cl. G06F 1/20; F28F 7/00

(52) U.S. Cl. 361/679.54; 165/185

(57) ABSTRACT

A heat dissipating device includes a heat sink and a number of cooling members. A number of grooves are defined in a bottom of the heat sink. Each cooling member includes a first cooling piece, a second piece opposite to the first cooling piece, and a connection piece connected between tops of the first cooling piece and the second cooling piece. The heat sink is fixed on tops of the cooling members, with the connection pieces of the cooling members received in the corresponding grooves of the heat sink.

### BACKGROUND

1. Technical Field

The present disclosure relates to a heat dissipating device.

2. Description of Related Art

It is well known that many electronic systems comprising many memories generate a large amount of heat, and the heat must be promptly removed from the memories to ensure proper operation. Generally, cooling members are mounted on the memories to remove the heat. However, due to limited available space, cooling members are small, and correspondingly have limited heat dissipation capability. Thus, the heat generated by the memories may not be removed rapidly enough.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a heat dissipating device, together with a plurality of memories.

FIG. 2 is an assembled, isometric view of the heat dissipating device and the memories of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

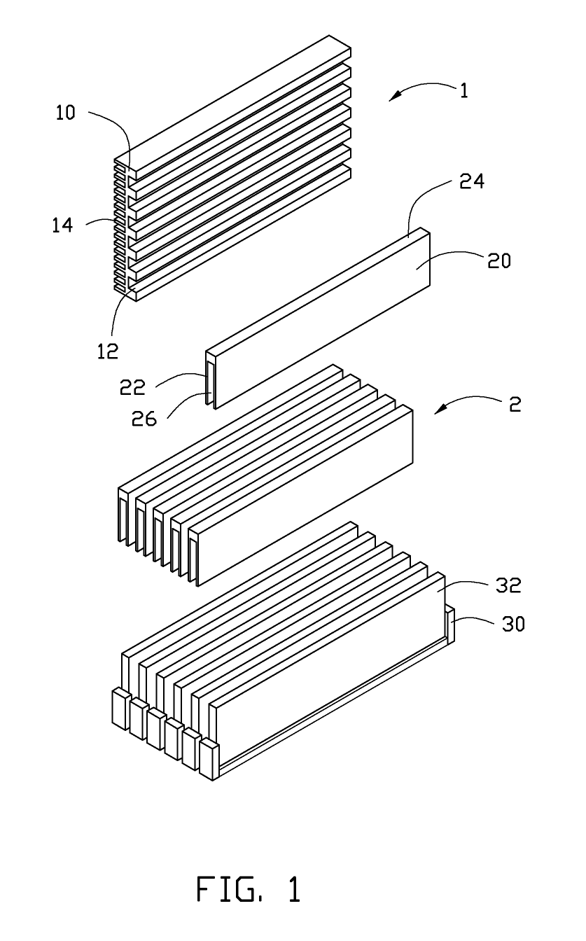

Referring to FIG. 1, an embodiment of a heat dissipating device used for cooling a plurality of memories 32 inserted into slots 30. The heat dissipating device includes a heat sink 1, and a plurality of substantially U-shaped cooling members 2.

The heat sink 1 includes a base 10, and a plurality of cooling fins 12 extending from a top of the base 10. A plurality of grooves 14 are defined in a bottom of the base 10.

Each cooling member 2 includes a first cooling piece 20, a second cooling piece 22 opposite and parallel to the first cooling piece 20, and a connection piece 24 perpendicularly connected between tops of the first cooling piece 20 and the second cooling piece 22. A receiving space 26 is bounded by the first cooling piece 20, the second cooling piece 22, and the connection piece 24.

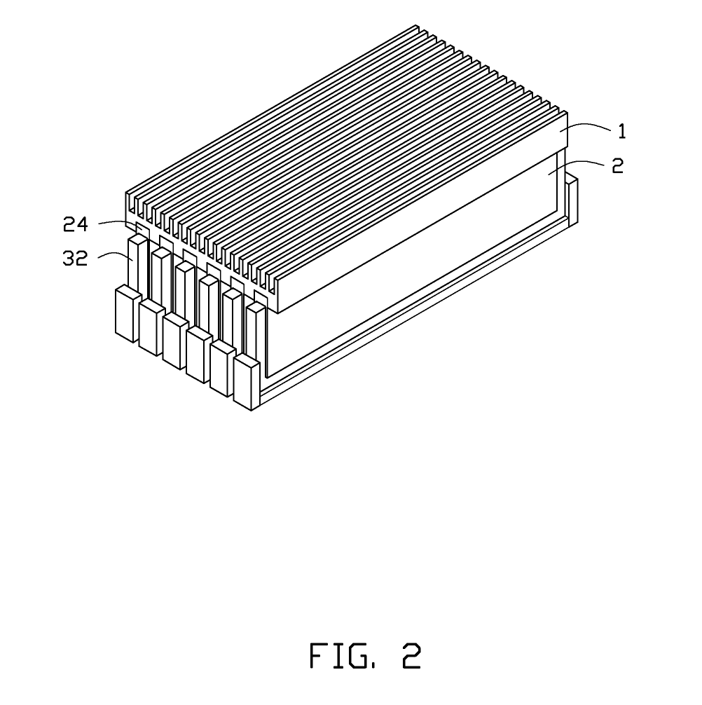

Referring to FIG. 2, in assembly, each cooling member 2 is attached to a corresponding memory 32 to receive the memory 32 in the receiving space 26, with the first and second cooling pieces 20 and 22 sandwiching the memory 32 and the connection piece 24 supported on a top of the memory 32. The heat sink1 is fixed on tops of the cooling members 2, with the supporting pieces 24 of the cooling members 2 received in the corresponding grooves 12 in the bottom of the heat sink 1.

It is believed that the present embodiments and their advantages will be understood from the foregoing description, and they will be apparent that various changes may be made thereto without departing from the spirit and scope of the description or sacrificing all of their material advantages, the examples hereinbefore described merely being exemplary embodiment.

What is claimed is:

1. A heat dissipating device, comprising:
a plurality of cooling members each comprising a first cooling piece, a second cooling piece opposite to the first cooling piece, and a connection piece connected between tops of the first and second cooling pieces; and
a heat sink defining a plurality of grooves in a bottom of the heat sink;
wherein the heat sink is mounted on the cooling members, with the connection pieces of the cooling members received in the plurality of grooves in the bottom of the heat sink.

2. The heat dissipating device of claim 1, wherein a plurality of fins extends from the heat sink, opposite to the plurality of grooves.

3. The heat dissipating device of claim 1, wherein a receiving space is formed by the first cooling piece, the second piece, and the supporting piece to receive a memory.

4. The heat dissipating device of claim 1, wherein each connection piece is received in a corresponding one of the plurality of grooves.

5. A memory assembly, comprising:
a plurality of memories; and
a heat dissipating device for dissipating heat from the memories, comprising:
a plurality of cooling members each comprising a first cooling piece, a second cooling piece opposite to the first cooling piece, and a connection piece connected between tops of the first and second cooling pieces, a receiving space being formed by the first and the second cooling pieces and the connection piece, each of the plurality of memories being received in one of the receiving spaces; and
a heat sink defining a plurality of grooves in a bottom of the heat sink;
wherein the heat sink is mounted on the cooling members, with the connection pieces of the cooling members received in the plurality of grooves in the bottom of the heat sink.

6. The memory assembly of claim 5, wherein a plurality of fins extends from the heat sink, opposite to the plurality of grooves.

7. The memory assembly of claim 5, wherein a receiving space is formed by the first cooling piece, the second piece, and the supporting piece to receive a memory.

8. The memory assembly of claim 5, wherein each connection piece is received in a corresponding one of the plurality of grooves.
